(19) United States
(12) Patent Application Publication
(10) Pub. No.: US 2002/0160135 A1
(43) Pub. Date: Oct. 31, 2002

(54) Polylmeric films and packages produced therefrom

(76) Inventors: Roy Christopherson, Wiltshire (GB); David Thomas Stell, Bristol (GB)

Correspondence Address: BLANK ROME COMISKY & MCCAULEY, LLP, 900 17TH STREET, N.W., SUITE 1000, WASHINGTON, DC, 20006, US

(21) Appl. No.: 09/959,803

(22) PCT Filed: Mar. 8, 2001
(86) PCT No.: PCT/GB01/01000

(30) Foreign Application Priority Data
Mar. 8, 2000 (GB) 0005541.8

(51) Int. Cl. B32B 1/02

(52) U.S. Cl. 428/35.7

(57) ABSTRACT

Heat sealable polymeric films having a heat sealable surface comprising a blend of at least one polyethylene and a cyclic olefin/ethylene copolymer having a glass transition temperature T_{g} of greater than 30° C. Such films can be used to form packages showing good peelability, usually with evidence of peeling, after heat sealing to various substrates. These packages are of particular use for packaging foodstuffs and medicaments.

This invention concerns polymeric films and packages produced therefrom, and more particularly films which can be used to produce packages which can be readily peeled open.

Peel open packaging made from polymeric films is widely used in the packaging of many products, for example foodstuffs, and also medical products and equipment. Typically, these films are heat sealed to a substrate, for example a polymeric film or web, or a web of some other material, for example a non-woven web or a metal foil, with the product therebetween. Peeling of the heat seal then permits access to the contents of the package without the necessity to cut open the packaging to access its contents.

In order to be able to peel open such heat seals, either the strength of the seals themselves needs to be less than that of the materials which have been heat sealed together, in which case the heat seal itself peels open by failure of the heat seal at the sealing interface, or if the seal is to peel open without opening at the sealing interface, the packaging materials themselves have to be capable of permitting peeling within their thicknesses. Without this, it becomes impossible to open the packages without tearing the packaging materials or in extreme cases cutting them open because the packaging materials and the heat seals are simply too strong.

The disadvantage with using heat seals which peel by failure at the heat sealing interface is that peeling relies on the inherent weakness of the heat seal, and since there will inevitably be a range of strengths of seal produced even when sealing the same two materials together, unreliable sealing often results. Not only is this undesirable in any packaging situation, it is totally unacceptable in others, for example in packaging foodstuffs and medical products.

As will be appreciated, the problem becomes even more acute when heat seals are to be produced between a particular film and different substrates. However, heat seals between polymeric films and fibrous materials such as non-wovens simply cannot peel open by delamination of the heat seal unless there has been minimal penetration of the heat seal material into the non-woven. Furthermore, the strength of the seal between the heat seal layer of the polymeric film and the surface of the substrate to which it has been heat sealed can vary widely according to the nature of the substrate.

The above problems can be overcome by the use of heat sealable films which form seals with high strengths to a variety of materials, and to make the films such that peeling occurs within the films rather than by delamination of the heat seal itself. Peeling can then take place by one of two mechanisms, the first being delamination of two layers of a multi-layered film, peeling then occurring at the interface between these two layers, or by tearing within the thickness of a layer of a multi-layered film. The advantage with this approach is that provided the strength of the heat seal is greater than the peel strength of these heat seals, the force required to open the packages is independent of the heat seal strength. An additional advantage of the second of these methods is that the peeled seal area often provides evidence that peeling has taken place because the optical properties of the sealed area and the peeled film often change as a result of the tearing which takes place within the thickness of the film.

Methods which have been proposed hitherto for providing layers of heat sealable polymeric films with layers which rupture internally during peeling in general rely on using materials which have relatively low internal cohesive strengths. This can be achieved by the use of particular blends of polymeric materials.

U.S. Pat. No. 4,361,237 describes films for sealing to polystyrene which have heat seal layers consisting of blends of 50 to 70 wt % of at least one ethylene polymer having a melt index of 0.5 to 7 g/10 min and selected from polyethylene having a density in the range of from 0.910 to 0.925 g/cm³ and an ethylene-vinyl acetate copolymer containing at most 7 wt % of vinyl acetate, 20 to 30 wt % of at least one ethylene-vinyl acetate copolymer containing 20 to 30 wt % of vinyl acetate and having a melt index of 0.5 to 7 g/10 min, and 10 to 20 wt % of a styrene homopolymer having a melt index of 0.5 to 7 g/10 min. These films form strong heat seals to polystyrene substrates, the seals peeling by failure within the thickness of the heat seal layer formed by these blends. However, the presence of polystyrene in these blends is undesirable for many packaging applications.

U.S. Pat. No. 4,367,312 describes heat sealable packaging films for heat sealing to a variety of substrates, in particular those formed from polyesters, polyvinyl chloride, polyamides and polyacrylonitrile, which consist of blends of 55 to 95 wt % of at least one ethylene polymer selected from polyethylene having a density in the range of from 0.91 to 0.93 g/cm³ and an ethylene-vinyl acetate copolymer containing at most 10 wt % of vinyl acetate, 5 to 20 wt % of polystyrene, and 0 to 20 wt % of a thermoplastic, elastomeric styrene-butadiene-styrene or styrene-isoprene-styrene block polymer, the face of the film which is intended to be heat sealed to the above substrates having a surface tension of from 35 to 50 mN/m, for example as a result of corona discharge treatment.

Other methods of imparting inherent weakness to layers within the thickness of polymeric films to facilitate peeling within the thickness of these layers include organic or inorganic particulate materials. Organic particulate materials which can be used include polymers which are incompatible with the base polymer forming the layer, for example blends of polypropylene with polyethylenes, polyesters, e.g. polyalkylene terephthalates, or polyamides, e.g. nylon. Inorganic particulate materials which can be used include particulate calcium carbonate and titanium dioxide. However, a particular disadvantage with these methods of imparting weakness within these layers is that the phase distinct particulate material usually has an adverse effect on the optical properties of the films making them hazy.

According to the present invention there is provided a heat sealable polymeric film having a heat sealable surface comprising a blend of at least one polyethylene and a cyclic olefin/ethylene copolymer having a glass transition temperature T_{g} of greater than 30° C.

Films in accordance with the present invention have been found to form good heat seals to polymeric materials and especially to ethylene based polymers. The strengths of these heat seals can be varied by changing the components of the blend forming the heat seal layer, and the heat seals can range in strength from those which peel by adhesive failure between the heat seal layer and the substrate to which the film of the present invention has been heat sealed, to seals which peel by cohesive failure of the heat seal layer itself, that is by rupture of the heat seal layer within its thickness.

Heat seals which peel by rupture within the thickness of the heat seal layer in general provide good evidence that the seal has been peeled.

Unlike a number of hitherto proposed films for producing peelable heat seals, films of the present invention have been found to produce minimal to zero stringing of the heat seal material when the seals are peeled.

A further advantage of films of the present invention is that the components of the blend forming the heat seal layer are acceptable for food contact use and for medicament contact use, the heat seal layer of the films often contacting the packaged products when these films are used as packaging materials.

The polyethylene used in the blend for the heat seal layer of films in accordance with the present invention can be selected from a wide variety of polyethylenes, for example having densities in the range of from 0.915 g/cm³ to 0.935 g/cm³. Thus the polyethylene can be selected from low density polyethylenes, medium density polyethylenes, and high density polyethylenes. However, the peel strength of the heat seals formed by films in accordance with the present invention appears to increase as the density of the polyethylene in the blend increases, and this can lead to unsatisfactory peeling of the seals.

The cyclic olefin/ethylene copolymer used in the blend for the heat sealable surface of films in accordance with the present invention will usually have a glass transition temperature T_{g} of greater than 30° C. but less than 220° C. A preferred range of glass transition temperatures for these copolymers is from 50 to 175° C., a particularly preferred range being from 65 to 180° C.

Preferred cyclic olefin/ethylene copolymers for use in accordance with the present invention are preferably norbornene/ethylene copolymers. The norbornene content of these polymers is preferably from 20 to 80 weight percent.

A particularly preferred cyclic olefin copolymer for use in the present invention is sold by Hoechst AG as COC8007 (glass transition temperature T_{g}=70° C.), and it is believed that this is a copolymer containing a minor proportion of units derived from norbornene and a major proportion of units derived from ethylene, with the copolymerisation having been effected in the presence of a metallocene catalyst. However, other cyclic olefin copolymers can be used containing units derived from norbornene or other cyclic olefins.

Although the peel strength of the heat seals formed by films in accordance with the present invention usually increase with increases in the temperature at which heat sealing is effect, the peel strengths also tend to increase with both the density and the amount of the polyethylene in the blend. Preferred blends for use in accordance with the present invention contain from 60 to 90 wt %, and from 40 to 10 wt % of a cyclic olefin/ethylene copolymer. More preferably they contain from 65 to 85 wt % of a polyethylene and from 35 to 15 wt % of a cyclic olefin/ethylene copolymer, especially preferred ranges being from 70 to 80 wt % of a polyethylene and from 30 to 20 wt % of a cyclic olefin/ethylene copolymer.

In general films in accordance with the present invention will provide heat seals which can be peeled satisfactorily if they have been formed at temperatures of from 110 to 150° C. under a load of 300 kPa with a dwell time of 1 sec. As will be appreciated, the use of different blends for the heat seal layer will usually require adjustment of the heat sealing conditions to provide seals which have sufficient strength not to open during transit but are not so strong as to prevent peeling of the seal. In general this requires the peel strength of the heat seal to be at least 2 N/15 mm but not more than about 6 N/15 mm.

Films in accordance with the present invention will usually consist of the specified heat seal layer and one or more further layers, and in general the choice of such further layers can be made from a wide variety of polymers depending on the end use of the films.

A preferred group of films in accordance with the present invention consists of a base layer of a polyolefin, and especially polyethylene, having the layer of the polyethylene/cyclic olefin copolymer blend on at least one surface thereof. In general the blends adhere sufficiently well to the polyolefin base layer that an intermediate adhesive is not required.

Whilst films consisting only of polyolefins are useful for many packaging applications, they are not satisfactory for others, and especially where high oxygen and/or water vapor barrier properties are required. Examples of such applications include the packaging of foodstuffs and medical products. In such cases, films in accordance with the present invention can include one or more layers of polymeric materials which impart such properties to films, for example polyvinyl alcohol and more particularly nylons.

The various layers of films of the present invention can be made to a variety of thicknesses depending on the end use to be made of them. However, it is generally preferred that the heat seal layer formed from the blend of polyethylene and a cyclic olefin copolymer is from 5 to 15 μm thick. Heat sealing and more particularly peeling of the heat seal can be adversely affected by making this layer too thin. However, increasing the thickness of this layer beyond the point where satisfactory heat sealing and peeling of the resultant seal is obtainable--can carry cost disadvantages. A particularly preferred thickness for this layer is about 10 μm.

The overall thickness of films in accordance with the present invention can also be selected according to the end use to be made of them. For most packaging applications their thicknesses will be from 30 to 350 μm, more particularly from 50 to 100 μm, and especially from 60 to 80 μm.

Films in accordance with the present invention can be made by known methods, a preferred method being to coextrude melts of the respective polymers through a slot die, followed by cooling the resultant web and then winding up the film.

Films in accordance with the present invention are preferably used for packaging where they will usually be heat sealed by the blend of the polyethylene/cyclic olefin copolymer to another polymeric film. Examples of such other polymeric films include polyethylene films, preferably including a layer of a polymer having oxygen and/or water vapor barrier properties, for example polyvinyl alcohol or a nylon.

Films in accordance with the present invention can be used in a variety of packaging applications. For example, they can be used as lidding films for polymeric containers or as webs for forming pouches and sachets. They can also by a suitable choice of the polymeric web to which the heat seal layer is applied be thermoformed, with the heat seal layer serving to adhere to a closure web. An example of this latter type of packaging is blister packs, for example for packaging for medicaments, the closure web being, for example, a coated metal foil through which the packaged product can be pushed when access to the product is desired.

The following Examples are given by way of illustration only. In the Examples, peel strengths were measured using a constant 90° peel test, using 50 mm length samples conducted at 100 mm/min on a Lloyd mechanical tensile tester. The test samples were produced by first adhering the respective four layered films of the present invention to the polyethylene/nylon laminate film, leaving a tab of the latter unadhered, and then adhering the reverse side of the film of the present invention to a 15 cm diameter wheel in the Lloyd mechanical tensile tester. The peel strengths of the heat seals were then measured by pulling the unadhered tab of the polyethylene/nylon laminate film perpendicularly away from the wheel and therefore away from the film of the present invention.

### EXAMPLE 1

A four layered polymeric film was produced by coextruding through a slot die a first outer layer 10 μm thick consisting of a blend of 80 wt % of a low density polyethylene (density 0.918 g/cm³) and 20 wt % of a cyclic olefin copolymer (COC8007 having a glass transition temperature T_{g} of 70° C.), a base layer 35 μm thick next to the first outer layer consisting of the low density polyethylene used in the blend forming the first outer layer, an intermediate layer 5 μm thick consisting of a maleic anhydride extended linear low density polyethylene based adhesive, and a second outer layer 20 μm thick on the intermediate layer and consisting of nylon 6. The overall thickness of the film was 70 μm.

This film was heat sealed by its surface consisting of the blend of low density polyethylene and the cyclic olefin copolymer to the polyethylene surface of a film consisting of a layer of low density polyethylene adhered by a maleic anhydride extended linear low density polyethylene based adhesive to a layer of nylon 6 using a pressure of 300 kPa for 1 sec at a temperature of 120° C., the heat being applied through the nylon/polyethylene film.

This seal had a peel strength of 3.8 N/15 mm, and it peeled by rupture within the thickness of the heat seal layer with transfer of heat seal material from the four layered film of the present invention to the polyethylene layer of the nylon/polyethylene film. This heat seal, which peeled by cohesive failure of the heat seal layer showed evidence of its having been peeled by a whitening of the peeled area of the heat seal.

Heat sealing of these films at 130, 140 and 150° C. under otherwise identical conditions resulted in peel strengths of 4.04, 4.07 and 4.5 N/15 mm respectively, with peeling being by the same mechanism and also showing evidence of peeling having taken place.

### EXAMPLE 2

A four layered film was produced in a similar manner to that described in Example 1 except that the heat seal layer was formed from a blend of 70 wt % of the low density polyethylene and 30 wt % of the cyclic olefin copolymer.

Heat sealing this film by its heat seal layer to the polyethylene surface of the polyethylene/nylon laminate film used in Example 1 at 120, 130, 140 and 150° C. under the conditions described in Example 1 resulted in heat seals having peel strengths of 1.96, 2.50, 4.75 and 2.87 N/15 mm respectively, peeling being by rupture within the heat seal layer. The peeled areas of the seals gave evidence of peeling by a whitening of the peeled area of the seal.

### EXAMPLE 3

A four layered polymeric film was produced by the method described in Example 1 except that the low density polyethylene having a density of 0.918 g/cm³ was replaced by the same amount of a low density polyethylene having a density of 0.930 g/cm³.

Heat sealing this film by its heat seal layer to the polyethylene surface of the polyethylene/nylon film used in Example 1 at 120, 130, 140 and 150° C. under the conditions described in Example 1 resulted in heat seals having peel strengths of 4.02, 4.48, 4.04 and 3.85 N/1 mm respectively, peeling being by rupture within the heat seal layer. The peeled areas of the seals gave evidence of peeling by a whitening of the peeled area of the seal.

### EXAMPLE 4

A four layered film was produced in a similar manner to that described in Example 2 except that the heat seal layer was formed from a blend of 70 wt % of the low density polyethylene and 30 wt % of the cyclic olefin copolymer.

Heat sealing this film by its heat seal layer to the polyethylene surface of the polyethylene/nylon laminate film used in Example 1 at 120, 130, 140 and 150° C. under the conditions described in Example 1 resulted in heat seals having peel strengths of 1.17, 1.83, 1.92 and 1.81 N/15 mm respectively.

### EXAMPLE 5

A four layered polymeric film was produced by the method described in Example 1 except that the low density polyethylene having a density of 0.918 g/cm³ was replaced by the same amount of a medium density polyethylene having a density of 0.935 g/cm³.

Heat sealing this film by its heat seal layer to the polyethylene surface of the polyethylene/nylon film used in Example 1 at 120, 130, 140 and 150° C. under the conditions described in Example 1 resulted in heat seals having peel strengths of 3.83, 4.48, 4.62 and 4.06 N/15 mm respectively, peeling being by rupture within the heat seal layer. The peeled areas of the seals gave evidence of peeling by a whitening of the peeled area of the seal.

### EXAMPLE 6

A four layered film was produced in a similar manner to that described in Example 5 except that the heat seal layer was formed from a blend of 70 wt % of the medium density polyethylene and 30 wt % of the cyclic olefin copolymer.

Heat sealing this film by its heat seal layer to the polyethylene surface of the nylon/polyethylene film used in Example 1 at 120, 130, 140 and 150° C. under the conditions described in Example 1 resulted in heat seals having peel strengths of 1.21, 1.84, 2.1 and 2.29 N/15 mm respectively, and the all peeled by rupture within the heat seal layer.

### EXAMPLE 7

A four layered polymeric film was produced by the method described in Example 1 except that the low density polyethylene having a density of 0.918 g/cm³ was replaced by the same amount of a linear medium density polyethylene having a density of 0.940 g/cm³.

Heat sealing this film by its heat seal layer to the polyethylene surface of the nylon/polyethylene film used in Example 1 at 120, 130, 140 and 150° C. under the conditions described in Example 1 resulted in heat seals having peel strengths of 2.77, 6.48, 7.94 and 9.74 N/15 mm respectively. Peeling in these cases was by failure of the adhesive bond between the heat seal layer and the polyethylene/nylon film. The film of the present invention showed some whitening in the peeled areas of the heat seals but it was less than in the case of cohesive peeling.

### EXAMPLE 8

A four layered film was produced in a similar manner to that described in Example 7 except that the heat seal layer was formed from a blend of 70 wt % of the linear medium density polyethylene and 30 wt % of the cyclic olefin copolymer.

Heat sealing this film by its heat seal layer to the polyethylene surface of the nylon/polyethylene film used in Example 1 at 120, 130, 140 and 150° C. under the conditions described in Example 1 resulted in heat seals having peel strengths of 3.38, 7.38, 8.66 and 6.56 N/15 mm respectively. Peeling in these cases was by failure of the adhesive bond between the heat seal layer and the polyethylene/nylon film. The film of the present invention showed some whitening in the peeled areas of the heat seals but it was less than in the case of cohesive peeling.

1. A heat sealable polymeric film having a heat sealable surface comprising a blend of at least one polyethylene and a cyclic olefin/ethylene copolymer having a glass transition temperature T_{g} of greater than 30° C.

2. A film according to claim 1, wherein the copolymer has a glass transition temperature T_{g} of less than 220° C.

3. A film according to either of the preceding claims, wherein the copolymer has a glass transition temperature T_{g} of from 50 to 175° C.

4. A film according to claim 3, wherein the copolymer has a glass transition temperature T_{g} of from 65 to 150° C.

5. A film according to any of the preceding claims, wherein the blend comprises from 60 to 90 wt % of polyethylene and from 40 to 10 wt % of the cyclic olefin/ethylene copolymer.

6. A film according to claim 5, wherein the blend comprises from 65 to 85 wt % of polyethylene and from 35 to 15 wt % of the cyclic olefin/ethylene copolymer.

7. A film according to claim 6, wherein the blend comprises from 70 to 80 wt % of polyethylene and from 30 to 20 wt % of the cyclic olefin/ethylene copolymer.

8. A film according to any of the preceding claims, wherein the cyclic olefin of the cyclic olefin/ethylene copolymer comprises norbornene.

9. A film according to any of the preceding claims, wherein the polyethylene has a density of from 0.915 g/cm³ to 0.935 g/cm³.

10. A film according to any of the preceding claims, wherein the heat sealable surface is formed by an outer layer of a multi-layered polymeric film.

11. A film according to claim 10, wherein the multi-layered film has a base layer comprising a polyolefin.

12. A film according to claim 11, wherein the polyolefin comprises a low density polyethylene.

13. A film according to any of the preceding claims, including a layer of a polymer having high barrier properties to oxygen.

14. A film according to claim 13, wherein the layer having high oxygen barrier properties comprises a nylon.

15. A peelable open package comprising a film according to any of the preceding claims heat sealed to a coated metal foil, a polymeric film or a non-woven web.
